(19) United States
(12) Patent Application Publication
(10) Pub. No.: US 2026/0355922 A1
(43) Pub. Date: Nov. 12, 2026

(54) POWERHEAD ATTACHMENT SYSTEM

(71) Applicant: Milwaukee Electric Tool Corporation, Brookfield, WI (US)

(72) Inventors: Quy V. Nguyen, Milwaukee, WI (US); John R. Jacobson, Brookfield, WI (US); Nathan T. Armstrong, Fox Point, WI (US); Karl A. Bachhuber-Beam, Brookfield, WI (US)

(21) Appl. No.: 19/670,851

(22) Filed: May 7, 2026

Related U.S. Application Data
(60) Provisional application No. 63/802,017, filed on May 8, 2025.

(51) Int. Cl. B25F 3/00; B25F 5/02

(52) U.S. Cl. CPC B25F 3/00; B25F 5/02

(57) ABSTRACT

A powerhead unit for an outdoor tool and a powered outdoor tool device are provided. A powerhead includes a motor, a first shaft segment having a first driveshaft segment coupled to the motor, and a first connecting portion attached to the first shaft segment. The first driveshaft segment defines a male connection member and a projection, and the motor defines a female connection member for receiving the male connection member. The female connection member includes an opening for receiving the male connection member and a slot intersecting the opening, the slot configured to receive the projection.

### CROSS-REFERENCE TO RELATED APPLICATIONS

The present application claims priority to U.S. Provisional Patent Application Serial No. 63/802,017 filed on May 8, 2025, the disclosure of which is incorporated by reference herein in its entirety.

### FIELD

The present disclosure relates generally to powered devices, and, more particularly, to a powerhead unit for a tool, such as an outdoor tool or power tool.

### BACKGROUND

Powered devices, such as outdoor tools (e.g., a trimmer, an edger, a pole saw, etc.), power tools, etc., may include an elongated shaft assembly extending between a powerhead unit and a powered attachment unit. The shaft assembly may include a number of separate shaft segments, which can be coupled and decoupled, for example, for shipping, storage, exchange of attachment units, etc.

However, existing powered devices, e.g., outdoor tools, having multiple separate shaft segments may implement a loose spline fit between segments of the driveshaft. In this manner, driveshaft segments may be misaligned due to the loose spline fit, reducing the efficiency of the powered device or preventing its use altogether until the driveshaft segment alignment is corrected.

Accordingly, improvedpowerhead attachment systemsare desired in the art. In particular, powerhead attachment systemswhich provide improved alignment of the driveshaft segments would be advantageous.

### BRIEF DESCRIPTION

Aspects and advantages of the present disclosure will be set forth in part in the following description, or may be obvious from the description, or may be learned through practice of the technology.

In accordance with one embodiment, a powered device is provided. The powered device includes a powerhead unit including a motor, a first shaft segment having a first driveshaft segment coupled to the motor, and a first connecting portion attached to the first shaft segment. The powered device further includes an attachment unit selectively attachable to and powered by the powerhead unit. The attachment unit includes an operational unit configured to be driven by the motor, a second shaft segment having a second driveshaft segment operatively coupled to the operational unit, and a second connecting portion attached to the second shaft segment. The second connecting portion is configured for coupling to the first connecting portion. The first driveshaft segment defines a male connection member, and one of the motor and the second driveshaft segment defines a female connection member for receiving the male connection member.

In accordance with another embodiment, a powerhead unit for an outdoor tool is provided. The outdoor tool further includes an attachment unit selectively engageable with the powerhead unit and having an operational unit configured to be driven by the powerhead unit. The powerhead unit includes a motor, a first shaft segment having a first driveshaft segment coupled to the motor, and a first connecting portion attached to the first shaft segment. The first driveshaft segment defines a male connection member and a projection, and the motor defines a female connection member for receiving the male connection member. The female connection member includes an opening for receiving the male connection member and a slot intersecting the opening, the slot configured to receive the projection.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a powered device, such as an outdoor tool, a power tool, etc., including a powerhead unit and an attachment unit in accordance with embodiments of the present disclosure;

FIG. 2A is a perspective view of the attachment unit of FIG. 1 including a string trimmer attachment for use with the powerhead unit in accordance with embodiments of the present disclosure;

FIG. 2B is a perspective view of the attachment unit of FIG. 1 including an edger attachment for use with the powerhead unit in accordance with embodiments of the present disclosure;

FIG. 2C is a perspective view of the attachment unit of FIG. 1 including a hedge trimmer attachment for use with the powerhead unit in accordance with embodiments of the present disclosure;

FIG. 2D is a perspective view of the attachment unit of FIG. 1 including a pole saw attachment for use with the powerhead unit in accordance with embodiments of the present disclosure;

FIG. 3 is a perspective view of a powerhead unit in accordance with embodiments of the present disclosure;

FIG. 4 is a cross-sectional side view of a powerhead unit in accordance with embodiments of the present disclosure;

FIG. 5 is a cross-sectional side view of a portion of a powerhead unit in accordance with embodiments of the present disclosure;

FIG. 6 is a side perspective view of the motor output shaft of a powerhead unit in accordance with embodiments of the present disclosure;

FIG. 7 is a side perspective view of a first end of a first driveshaft segment of the powerhead unit in accordance with embodiments of the present disclosure;

FIG. 8 is a side perspective view of the assembly of a first driveshaft segment and a motor output shaft in accordance with embodiments of the present disclosure;

FIG. 9 is a side perspective view of a second driveshaft segment of an attachment unit in accordance with embodiments of the present disclosure

FIG. 10 is a side perspective view of a second end of a first driveshaft segment of the powerhead unit in accordance with embodiments of the present disclosure;

FIG. 11 is a cross-sectional side view of the connection between a powerhead unit and an attachment unit in accordance with embodiments of the present disclosure;

FIG. 12 is a perspective view of a connecting portion of a powerhead unit and an attachment unit in accordance with embodiments of the present disclosure in a disassembled state; and

FIG. 13 is a perspective view of a connecting portion of a powerhead unit and an attachment unit in accordance with embodiments of the present disclosure in an assembled state.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a powered device having a powerhead unit attachable to an attachment unit. The powered device includes a powerhead unit including a motor, a first shaft segment having a first driveshaft segment coupled to the motor, and a first connecting portion attached to the first shaft segment. The powered device further includes an attachment unit selectively attachable to and powered by the powerhead unit. The attachment unit includes an operational unit configured to be driven by the motor, a second shaft segment having a second driveshaft segment operatively coupled to the operational unit, and a second connecting portion attached to the second shaft segment. The second connecting portion is configured for coupling to the first connecting portion. The first driveshaft segment defines a male connection member, and one of the motor and the second driveshaft segment defines a female connection member for receiving the male connection member. The present inventors have found that the male and female connections between the first driveshaft segment and both the motor and the second driveshaft segment enable improved control of the rotation of the driveshafts by reducing the potential for misalignment between the motor, the first driveshaft segment, and the second driveshaft segment.

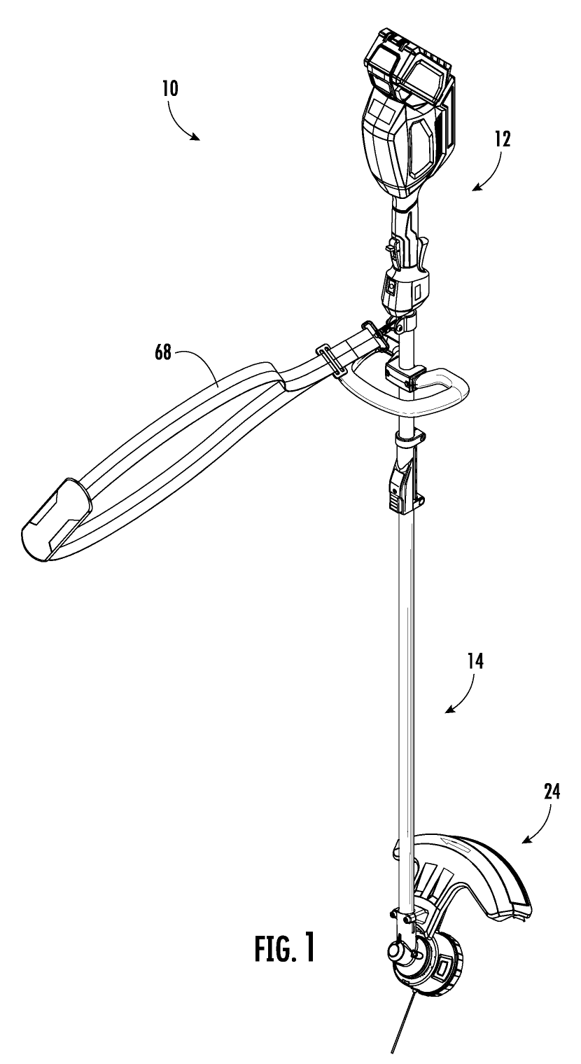

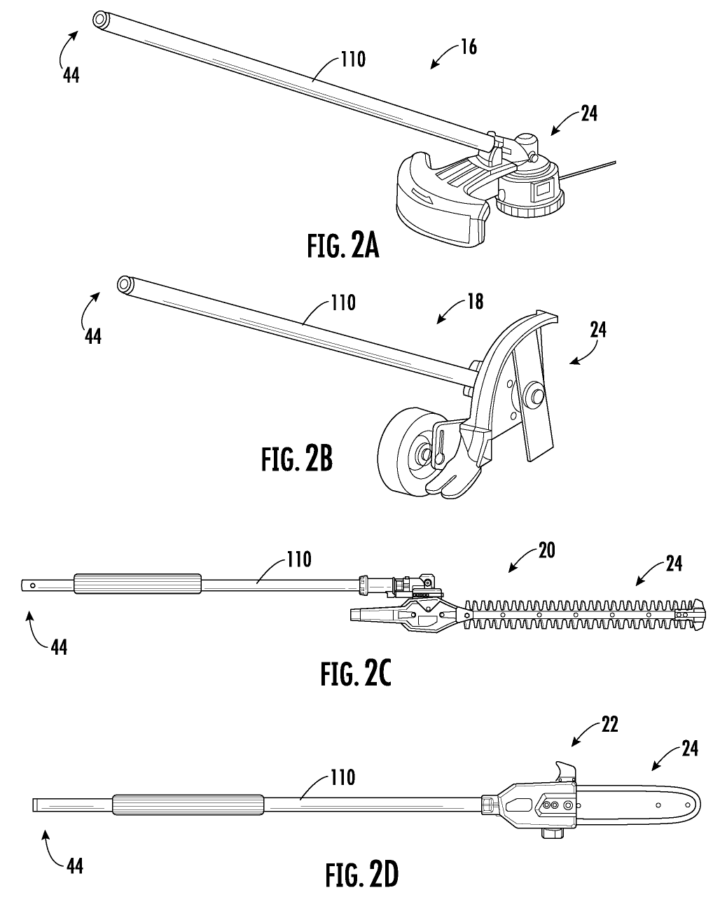

Referring now to the drawings, FIG. 1 illustrates a powered device, such as an outdoor tool 10, a power tool, etc., including a powerhead unit 12 and an attachment unit 14 selectively and removably coupled to the powerhead unit 12. As shown in FIG. 1, the illustrated attachment unit 14 includes a string trimmer attachment 16 (see FIG. 2A). In other constructions, such as those illustrated in FIGS. 2B-2D, the attachment unit 14 may include an edger attachment 18, a hedge trimmer attachment 20, and a pole saw attachment 22. In further constructions (not shown), the attachment unit 16 may include another tool attachment (e.g., a blower attachment, a cultivator attachment, a saw attachment, a drill attachment, etc.). Each of the attachment units 14, 16, 18, 20, 22, etc. is selectively attachable and engageable with the powerhead unit 12. The powerhead unit 12 and the various attachment units 14, 16, 18, 20, 22, etc., form a family of powered devices.

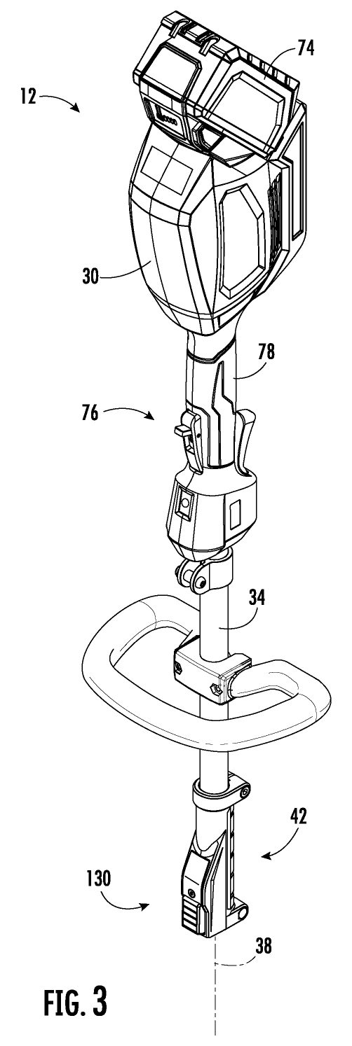

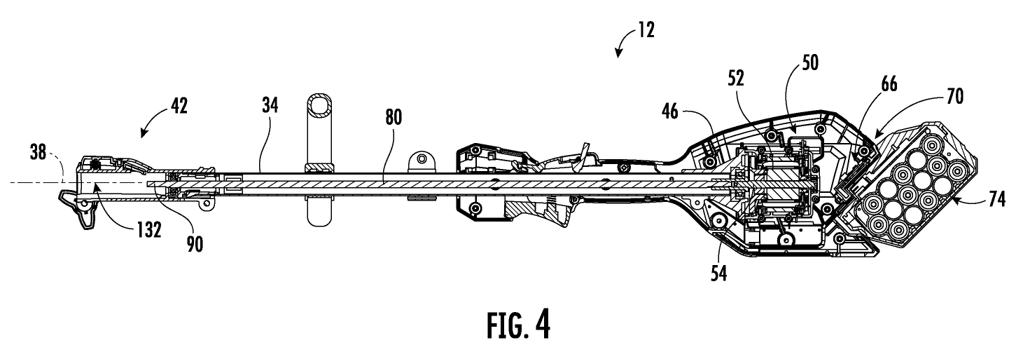

FIGS. 3-8 illustrate the powerhead unit 12 in more detail. The powerhead unit 12 includes a powerhead 30 and a first shaft segment 34 extending along a shaft axis 38 between the powerhead 30 and a first connecting portion 42. The powerhead 30 includes a housing assembly 46 formed, in the illustrated construction, of two clamshell housing halves connected along a plane. Together, the housing halves define a compartment 50 (FIG. 4) containing a motor 52 and other internal components 66 of the powerhead 30. A support strap 68 is selectively coupled to the powerhead unit 12 to support the outdoor tool.

The housing assembly 46 includes a battery attachment portion 70 (FIG. 4) configured to selectively mechanically and electrically connect to a rechargeable battery pack 74. The housing assembly 46 also includes a handle 78 (FIG. 3) supporting a trigger assembly 76 operable to selectively electrically connect the power source (e.g., the battery pack 74) and the motor 52.

With reference to FIG. 4, a first driveshaft segment 80 extends along the shaft axis 38 and within the first shaft segment 34 between the motor 52 and the first connecting portion 42. In the illustrated construction, the first driveshaft segment 80 is drivingly coupled at one end to a motor output shaft 54, e.g., via a first male connection member 82, and terminates at the other end in a second male connection member 90 (e.g., a spline) within the first connecting portion 42.

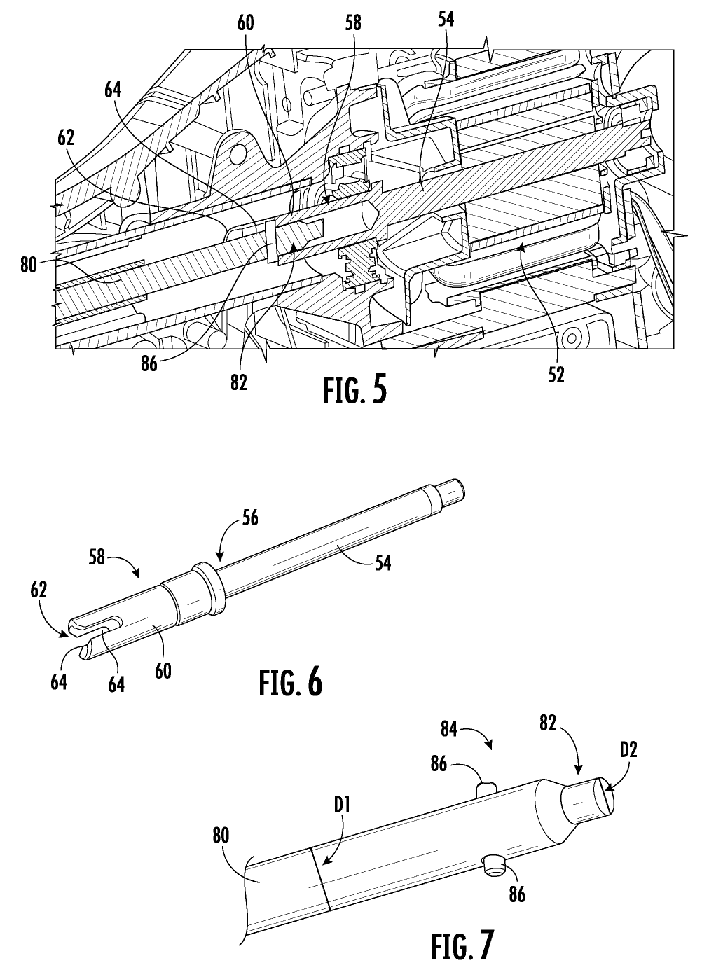

FIGS. 5-8 illustrate the connection between the first shaft segment 34 and the motor 52 in greater detail. As shown in FIGS. 5 and 6, the motor output shaft 54 includes a first female connection member 58 coupled to an output end 56 of the motor output shaft 54. For instance, the female connection member 58 may be integrally formed with the motor output shaft 54, i.e., formed as one piece. The female connection member 58 includes a generally tubular portion 60 having an opening 62 at an end thereof opposite the motor output shaft 54. For instance, the generally tubular portion 60 may have a generally cylindrical shape, or any other suitable shape to receive the first male connection member 82.

The female connection member 58 further includes a slot 64 extending axially along a portion of the generally tubular portion 60. The slot 64 intersects with the opening 62. For instance, there may be two slots 64 intersecting with the opening 62. In some aspects, the slots 64 may be circumferentially opposite each other about the opening 62. Stated differently, the slots 64 may be arranged about 180 degrees apart about the opening 62.

A first end 84 of the first driveshaft segment 80 is shown in detail in FIG. 7. The first male connection member 82 is located at the first end 84 of the first driveshaft segment 80. The first male connection member 82 may form a projection or spline extending from the first end 84 of the first driveshaft segment 80. The first driveshaft segment 80 may have a first diameter D1. The first male connection member 82 may have a second diameter D2 that is smaller than the first diameter D1 to distinguish the first male connection member 82 from the remaining length of the first driveshaft segment 80. In this manner, the first male connection member 82 may be inserted into a complementary receiving opening of a female connection member, e.g., the first female connection member 58. In some aspects, a transition section 84 may be provided between the first diameter D1 of the first driveshaft segment 80 and the second diameter D2 of the first male connection member 82. The transition section 84 may optionally have a tapered diameter from D1 to D2, such as a linear taper.

The first driveshaft segment 80 further includes a projection 86 arranged proximate to the first male connection member 82 at the first end 84. The projection 86 extends radially outward from the first driveshaft segment 80, e.g., at about a perpendicular angle relative to the axis 38. In some aspects, the projection 86 is formed by a pin extending from the first driveshaft segment 80. As shown in FIG. 7, the pin 86 may extend through an entire diameter (i.e., the diameter D1) of the first driveshaft segment 80. In this regard, the pin 86 may extend from two sides of the first driveshaft segment 80. More specifically, the pin 86 may extend from two opposite sides, about 180 degrees apart, when the pin 86 is a linear pin.

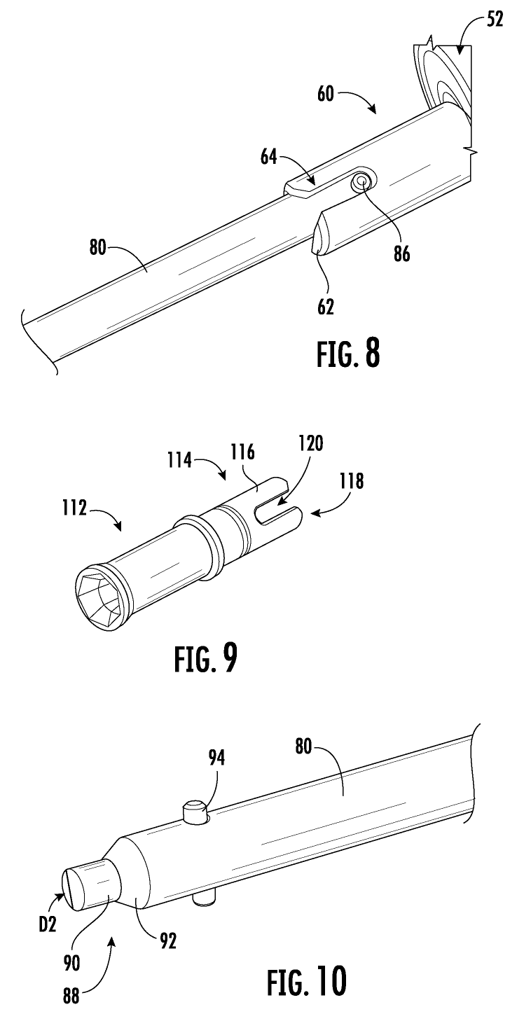

As shown in FIGS. 5 and 8, the pin 86 may extend through both slots 64 of the first female connection member 58 when the first female connection member 58 receives the first male connection member 82. In this manner, the connection between the pin 86 and the slots 64 may rotationally fix the position of the first driveshaft segment 80 relative to the motor output shaft 54, preventing any slippage or relative motion between the motor output shaft 54 and the first driveshaft segment 80 that could result from a loose fit (i.e., without the pin 86 arranged in the slots 64). As a result, rotation of the motor output shaft 54 directly causes rotation of the first driveshaft segment 80.

With reference to FIGS. 1-2D and 9-13, each attachment unit 14 includes an operational unit 24 (e.g., a string trimmer head, a hedge trimmer head, an edger head, a saw blade, etc.), a second connecting portion 44, and a second shaft segment 110 extending between the operational unit 24 and the second connecting portion 44. A second driveshaft segment 112 (FIG. 9) is rotatably coupled to the operational unit 24 and extends within the second shaft segment 110 between the operational unit 24 and the second connecting portion 44.

In the illustrated construction, as best shown in FIGS. 9-11, the second driveshaft segment 112 terminates at the second connecting portion 44 in a second female connection member 114. For instance, the second female connection member 114 may be integrally formed with the second driveshaft segment 112, i.e., formed as one piece. The second female connection member 114 includes a generally tubular portion 116 having an opening 118 at an end thereof. For instance, the generally tubular portion 116 may have a generally cylindrical shape, or any other suitable shape to receive the second male connection member 90.

The second female connection member 114 further includes a slot 120 extending axially along a portion of the generally tubular portion 116. The slot 120 intersects with the opening 118. For instance, there may be two slots 120 intersecting with the opening 118. In some aspects, the slots 120 may be radially opposite each other about the opening 118. Stated differently, the slots 120 may be arranged about 180 degrees apart about the opening 118.

A second end 88 of the first driveshaft segment 80 is shown in detail in FIG. 10. The second male connection member 90 is located at the second end 88 of the first driveshaft segment 80. The second male connection member 90 may form a projection or spline extending from the second end 88 of the first driveshaft segment 80. The first driveshaft segment 80 may have a first diameter D1. The second male connection member 90 may have a second diameter D2 that is smaller than the first diameter D1 to distinguish the second male connection member 90 from the remaining length of the first driveshaft segment 80. In this manner, the second male connection member 90 may be inserted into a complementary receiving opening of a female connection member, e.g., the second female connection member 114. In some aspects, a transition section 92 may be provided between the first diameter D1 of the first driveshaft segment 80 and the second diameter D2 of the second male connection member 90. The transition section 92 may optionally have a tapered diameter from D1 to D2, such as a linear taper.

The first driveshaft segment 80 further includes a projection 94 arranged adjacent to the second male connection member 90 at the second end 88. The projection 94 extends radially outward from the first driveshaft segment 80, e.g., at about a perpendicular angle relative to the axis 38. In some aspects, the projection 94 is formed by a pin extending from the first driveshaft segment 80. As shown in FIG. 10, the pin 94 may extend through an entire diameter (i.e., the diameter D1) of the first driveshaft segment 80. In this regard, the pin 94 may extend from two sides of the first driveshaft segment 80. More specifically, the pin 94 may extend from two opposite sides, about 180 degrees apart, when the pin 94 is a linear pin.

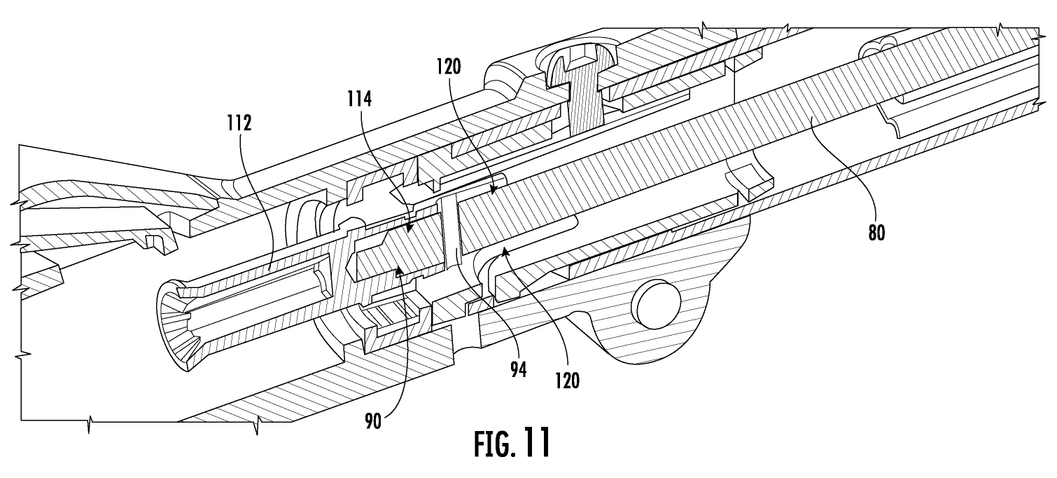

As shown in FIG. 11, the pin 94 may extend through both slots 120 of the second female connection member 114 when the second female connection member 114 receives the second male connection member 90. In this manner, the connection between the pin 94 and the slots 120 may rotationally fix the position of the first driveshaft segment 80 relative to the second driveshaft segment 112, preventing any slippage or relative motion between the second driveshaft segment 112 and the first driveshaft segment 80 that could result from a loose fit (i.e., without the pin 94 arranged in the slots 120).

When the powerhead unit 12 is coupled to the attachment unit 14, the second male connection member 94 (FIG. 4) selectively engages and rotatably couples to the female connection member 114, so that rotary power is transmitted by the driveshaft segments 80, 112 from the motor 52 to the operational unit 24, as discussed in greater detail below.

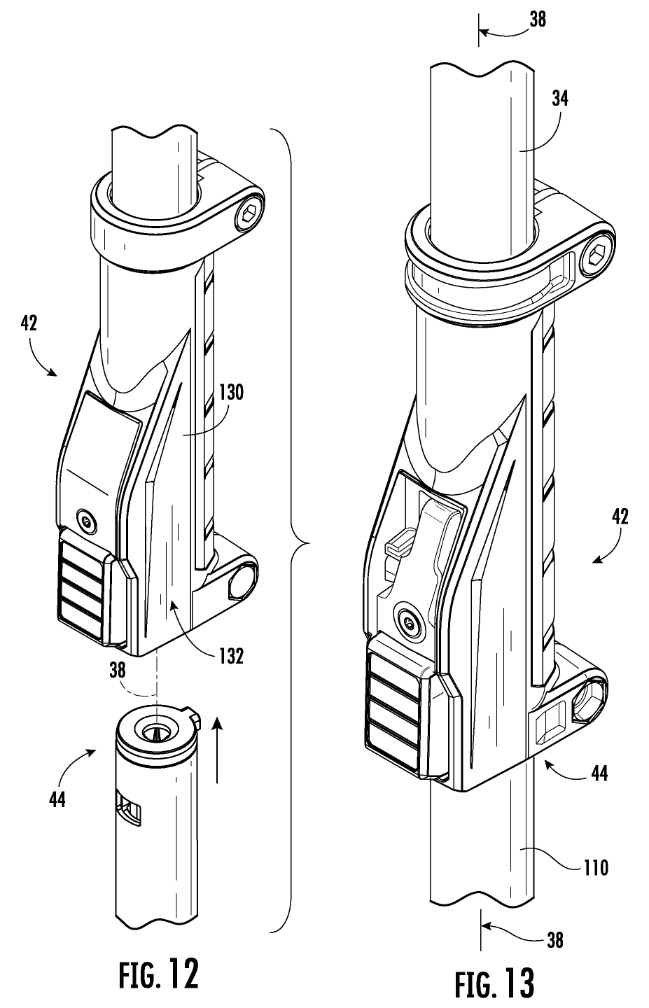

FIGS. 12-13 illustrate the first shaft segment 34, the first connecting portion 42, and a second handle 130 coupled to the first shaft segment 34. The first connecting portion 42 defines an envelope 132 (FIG. 12) with an axial opening for receiving the second connecting portion 44 of the attachment unit 14. The second male connection member 90 resides entirely within the opening of the envelope 132 so that the envelope 132 protects the first connecting portion 42 (e.g., the second male connection member 90) against damage (e.g., from dropping) when the attachment unit 14 is detached from the powerhead unit 12.

To assemble the powerhead unit 12 to the attachment unit 14, the second connecting portion 44 is inserted into the axial opening of the envelope 132 of the first connecting portion 42. The second male connection member 90 engages the second female connection member 144 to drivingly couple the first driveshaft segment 80 to the second driveshaft segment 112.

Further aspects of the disclosure are provided by one or more of the following embodiments:

A powered device includes a powerhead unit including a motor, a first shaft segment having a first driveshaft segment coupled to the motor, and a first connecting portion attached to the first shaft segment. The powered device further includes an attachment unit selectively attachable to and powered by the powerhead unit. The attachment unit includes an operational unit configured to be driven by the motor, a second shaft segment having a second driveshaft segment operatively coupled to the operational unit, and a second connecting portion attached to the second shaft segment. The second connecting portion is configured for coupling to the first connecting portion. The first driveshaft segment defines a male connection member, and one of the motor and the second driveshaft segment defines a female connection member for receiving the male connection member.

The powered device of any one or more of the embodiments, further comprising a pin extending radially outward from the first driveshaft segment proximate to the male connection member.

The powered device of any one or more of the embodiments, wherein the pin extends through the first driveshaft segment and extends outward from two sides of the driveshaft segment.

The powered device of any one or more of the embodiments, wherein the female connection member comprises a slot configured to receive the pin.

The powered device of any one or more of the embodiments, wherein the slot extends axially along the female connection member.

The powered device of any one or more of the embodiments, wherein the female connection member comprises an opening, wherein the slot intersects the opening.

The powered device of any one or more of the embodiments, wherein the slot is a first slot configured to receive a first end of the pin, the female connection member further comprising a second slot configured to receive a second end of the pin.

The powered device of any one or more of the embodiments, wherein the male connection member of the first driveshaft segment is a first male connection member at a first end of the first driveshaft segment, the first driveshaft segment further comprising a second male connection member at a second end of the first driveshaft segment.

The powered device of any one or more of the embodiments, wherein the motor defines the first female connection member, further wherein the second driveshaft segment defines a second female connection member for receiving the second male connection member.

The powered device of any one or more of the embodiments, wherein the motor comprises a motor comprises a motor output shaft, the motor output shaft defining the female connection member for receiving the male connection member.

The powered device of any one or more of the embodiments, wherein the motor shaft and the female connection member are integrally formed as one piece.

The powered device of any one or more of the embodiments, wherein when the attachment unit is attached to the powerhead unit, the first driveshaft segment engages the second driveshaft segment to rotationally couple the motor and the operational unit.

The powered device of any one or more of the embodiments, wherein when the attachment unit is attached to the powerhead unit, the male connection member is selectively received by the female connection member to rotationally couple the first driveshaft segment to the second driveshaft segment.

The powered device of any one or more of the embodiments, wherein the first driveshaft segment has a first diameter, and the male connection member has a second diameter that is smaller than the first diameter.

The powered device of any one or more of the embodiments, wherein the second diameter of the male connection member is arranged at an end of the first driveshaft segment, and the male connection member further includes a transition section from the first diameter to the second diameter.

The powered device of any one or more of the embodiments, further comprising a pin extending radially outward from the second diameter of the first driveshaft segment proximate to the male connection member.

A powerhead unit for an outdoor tool is provided. The outdoor tool further includes an attachment unit selectively engageable with the powerhead unit and having an operational unit configured to be driven by the powerhead unit. The powerhead unit includes a motor, a first shaft segment having a first driveshaft segment coupled to the motor, and a first connecting portion attached to the first shaft segment. The first driveshaft segment defines a male connection member and a projection, and the motor defines a female connection member for receiving the male connection member. The female connection member includes an opening for receiving the male connection member and a slot intersecting the opening, the slot configured to receive the projection.

The powerhead unit of any one or more of the embodiments, wherein the projection comprises a first end extending radially in a first direction from the first shaft segment and a second end extending radially from the first shaft segment in a second direction.

The powerhead unit of any one or more of the embodiments, wherein the female connection member further comprises a second slot, wherein the first end of the projection is received in the slot and the second end of the projection is received in the second slot.

The powerhead unit of any one or more of the embodiments, wherein the female connection member is integrally formed with an output shaft of the motor.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A powered device comprising:
a powerhead unit including a motor, a first shaft segment having a first driveshaft segment coupled to the motor, and a first connecting portion attached to the first shaft segment; and
an attachment unit selectively attachable to and powered by the powerhead unit, the attachment including an operational unit configured to be driven by the motor, a second shaft segment having a second driveshaft segment operatively coupled to the operational unit, and a second connecting portion attached to the second shaft segment, the second connecting portion configured for coupling to the first connecting portion,
wherein the first driveshaft segment defines a male connection member, and one of the motor and the second driveshaft segment defines a female connection member for receiving the male connection member.

2. The powered device of claim 1, further comprising a pin extending radially outward from the first driveshaft segment proximate to the male connection member.

3. The powered device of claim 2, wherein the pin extends through the first driveshaft segment and extends outward from two sides of the driveshaft segment.

4. The powered device of claim 2, wherein the female connection member comprises a slot configured to receive the pin.

5. The powered device of claim 4, wherein the slot extends axially along the female connection member.

6. The powered device of claim 4, wherein the female connection member comprises an opening, wherein the slot intersects the opening.

7. The powered device of claim 4, wherein the slot is a first slot configured to receive a first end of the pin, the female connection member further comprising a second slot configured to receive a second end of the pin.

8. The powered device of claim 1, wherein the male connection member of the first driveshaft segment is a first male connection member at a first end of the first driveshaft segment, the first driveshaft segment further comprising a second male connection member at a second end of the first driveshaft segment.

9. The powered device of claim 8, wherein the motor defines the first female connection member, further wherein the second driveshaft segment defines a second female connection member for receiving the second male connection member.

10. The powered device of claim 1, wherein the motor comprises a motor comprises a motor output shaft, the motor output shaft defining the female connection member for receiving the male connection member.

11. The powered device of claim 10, wherein the motor shaft and the female connection member are integrally formed as one piece.

12. The powered device of claim 1, wherein when the attachment unit is attached to the powerhead unit, the first driveshaft segment engages the second driveshaft segment to rotationally couple the motor and the operational unit.

13. The powered device of claim 12, wherein when the attachment unit is attached to the powerhead unit, the male connection member is selectively received by the female connection member to rotationally couple the first driveshaft segment to the second driveshaft segment.

14. The powered device of claim 1, wherein the first driveshaft segment has a first diameter, and the male connection member has a second diameter that is smaller than the first diameter.

15. The powered device of claim 14, wherein the second diameter of the male connection member is arranged at an end of the first driveshaft segment, and the male connection member further includes a transition section from the first diameter to the second diameter.

16. The powered device of claim 14, further comprising a pin extending radially outward from the second diameter of the first driveshaft segment proximate to the male connection member.

17. A powerhead unit for an outdoor tool, the outdoor tool further including an attachment unit selectively engageable with the powerhead unit and having an operational unit configured to be driven by the powerhead unit, the powerhead unit comprising:
a motor, a first shaft segment having a first driveshaft segment coupled to the motor, and a first connecting portion attached to the first shaft segment;
wherein the first driveshaft segment defines a male connection member and a projection, and
the motor defines a female connection member for receiving the male connection member,
the female connection member comprising an opening for receiving the male connection member and a slot intersecting the opening, the slot configured to receive the projection.

18. The powerhead unit of claim 17, wherein the projection comprises a first end extending radially in a first direction from the first shaft segment and a second end extending radially from the first shaft segment in a second direction.

19. The powerhead unit of claim 18, wherein the female connection member further comprises a second slot, wherein the first end of the projection is received in the slot and the second end of the projection is received in the second slot.

20. The powerhead unit of claim 17, wherein the female connection member is integrally formed with an output shaft of the motor.
